(19) United States
(12) Patent Application Publication
(10) Pub. No.: US 2007/0155252 A1
(43) Pub. Date: Jul. 5, 2007

(54) HOLDING FRAME FOR CONNECTOR MODULES

(76) Inventor: ALBERT FERDERER, Espelkamp (DE)

Correspondence Address: Norman P. Soloway;HAYES SOLOWAY P.C., 3450 E. Sunrise Drive, Suite 140, Tucson, AZ, 85718, US

(21) Appl. No.: 11/611,460

(22) Filed: Dec. 15, 2006

(30) Foreign Application Priority Data
Dec. 22, 2005 (DE) 202005020026.3

(51) Int. Cl. H01R 13/64

(52) U.S. Cl. 439/680

(57) ABSTRACT

The invention proposes a one-piece holding frame of plastic for a plug-type connector, in which several connector modules are arranged adjacent to one another, wherein several wall segments with window-like openings are formed in the collar-shaped mating side of said holding frame by means of slots. Two wall segments that lie opposite of one another respectively form a receptacle for one connector module, wherein projections arranged on the connector modules snap into the openings of the holding frame when the connector modules are inserted into the holding frame.

### BACKGROUND OF THE INVENTION

1. Field of the Invention

The invention pertains to a one-piece holding frame that consists of a plastic material and serves for accommodating several connector modules arranged adjacent to one another.

2. Description of the Related Art

A holding frame of this type is required for combining several connector modules with partially different mating configurations in a connector housing and to connect said connector modules to a corresponding mating connector.

DE 197 07 120 C1 discloses a mounting frame for holding connector modules, wherein this mounting frame is composed of two halves that are connected to one another in an articulated fashion, and wherein the connector modules that can be inserted into recesses in the mounting frame are held with a positive fit when the two halves are closed.

### SUMMARY OF THE INVENTION

Consequently, the invention is based on the objective of realizing a one-piece holding frame of plastic of the initially cited type in such a way that already known connector modules can be reliably interlocked and held therein. This objective is attained in that the holding frame features several wall segments on its mating side that are separated from one another by slots, wherein two wall segments that are arranged symmetrically opposite of one another respectively form a receptacle for one connector module. The advantages attained with the invention can be seen, in particular, in that a holding frame in the form of a one-piece moulded plastic part can be manufactured much easier, for example, than an articulated metallic holding frame. In addition, connector modules with electric contacts arranged therein can be inserted and interlocked in the holding frame more easily because the plastic materials slide very well on one another. To this end, the longitudinal walls of the collar-shaped holding frame on the mating side are divided into several wall segments by means of slots, wherein two wall segments that are arranged symmetrically opposite of one another respectively form a plug-in area or receptacle for one connector module.

It is also advantageous that the wall segments feature a window-like opening, above which a guide groove is arranged such that the connector modules provided with integral projections on the narrow sides can be inserted into a guide groove provided with an insertion ramp and the springable wall segments are briefly pressed outward before the projections snap into the openings.

In addition, the connector modules feature interlocking arms that are integrally moulded onto their narrow sides such that they act in the direction of the cable connection side and engage underneath the lateral collar wall when the projections snap into the openings such that two independent interlocking means fix the connector modules in the holding frame.

### BRIEF DESCRIPTION OF THE DRAWINGS

One embodiment of the invention is illustrated in the figures and described in greater detail below. The figures show:

FIG. 1 is a holding frame with connector modules viewed from the mating side, and

FIG. 2 is the holding frame with connector modules viewed from the cable connections.

### DESCRIPTION OF THE PREFERRED EMBODYMENTS

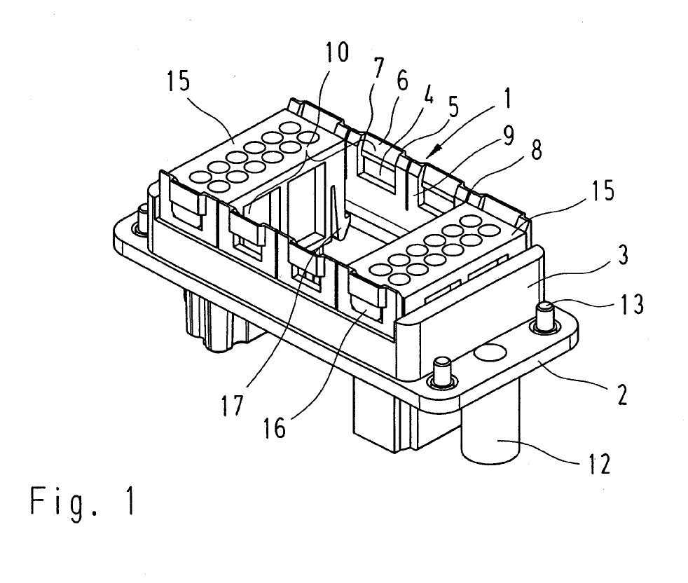

FIG. 1 shows a holding frame that is entirely made of plastic and designed for accommodating individual connector modules 15 to be inserted therein.

The holding frame features a rectangular flange-like frame 2 with a peripheral collar 3 integrally moulded thereon such that it extends perpendicular to the frame.

Window-like openings 4 are provided on the longitudinal sides, wherein the end of said openings on the mating side is formed by a window partition 5 that is outwardly offset by approximately the wall thickness.

Slots 8 are provided to both sides of the openings 4 and extend approximately to the center of the collar height such that they respectively form an elastic wall segment 9.

Two oppositely arranged wall segments 9 respectively form a receptacle 10 for one connector module.

When a connector module 15 is inserted into a receptacle 10 in the holding frame 1, the projections 16 arranged on the narrow sides of the connector module are initially inserted into the insertion ramps 6 of the guide grooves 7 such that the respectively opposite wall segments 9 are bent outward until the projections 16 snap into the window-like openings 4 and the wall segments spring back.

Interlocking arms 17 are also integrally moulded onto the narrow sides of the connector modules 15 and pressed together along the wall segments 9 when a connector module is inserted into the holding frame from the mating side, wherein said interlocking arms encounter an enlarged opening underneath the collar 3 that is formed by the flanged frame 2 situated underneath the collar such that the interlocking arms 17 are interlocked with the lower edge of the collar once they unbend outward. The modules therefore are secured in the holding frame by means of two independent interlocking means.

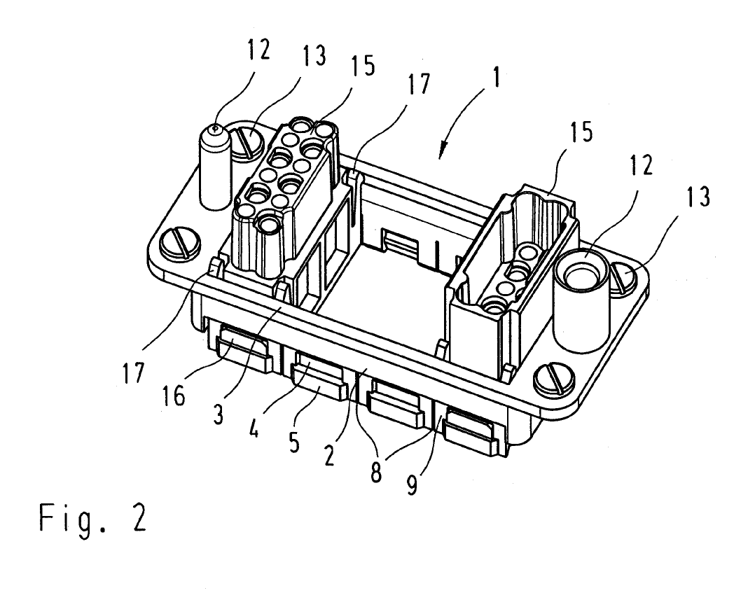

FIG. 2 shows the holding frame with two interlocked connector modules in the form of a view from the connection side.

Two encoding elements 12 realized in the form of a pin and a socket are arranged on the surfaces of the narrow sides of the frame-shaped flange 2 in order to ensure the non-interchangeable mating with a correspondingly designed mating connector.

On the outer edges of the flange, four screw elements 13 can be inserted into openings on the narrow sides, wherein said screw elements feature pins that penetrate the flange and serve for fixing the holding frame in a not-shown connector housing.

This figure also shows the interlocking of the connector modules, wherein the hook-shaped interlocking arms 17 are interlocked in the enlarged inner recess with the edge of the collar situated thereunder.

1. A holding frame comprised of a plastic material for accommodating several connector modules that are arranged adjacent to one another, wherein
the holding frame features several wall segments on its mating side that are separated by slots, wherein two wall segments that are arranged symmetrically opposite of one another respectively form a receptacle for one connector module.

2. The holding frame according to claim 1, wherein the wall segments feature window-like openings.

3. The holding frame according to claim 1, wherein the wall segments respectively feature a guide groove.

4. The holding frame according to claim 1, wherein the guide groove above the window-like opening is formed by a window partition that is integrally moulded onto an outer side of the wall segments and features a guide ramp on an inner side.
